(19) United States
(12) Patent Application Publication
(10) Pub. No.: US 2017/0263152 A1
(43) Pub. Date: Sep. 14, 2017

(54) MESSAGE DELIVERY DEVICE FOR THE VISUALLY IMPAIRED

(71) Applicant: Audible Easter Eggs for the Visually Impaired, Inc., Burke, VA (US)

(72) Inventor: Hung Cao, Panama City, FL (US)

(21) Appl. No.: 15/068,276

(22) Filed: Mar. 11, 2016

(51) Int. Cl. G09B 21/00

(52) U.S. Cl. CPC G09B 21/003; G09B 21/006

(57) ABSTRACT

Methods, systems, and apparatus for delivering a message to a visually impaired person. The method includes providing a device including a housing with an inner chamber and an outer surface, a power source, and a sound producing device coupled to the power source. The power source and sound producing device are contained within the inner chamber of the housing. Providing a mechanism to activate the sound producing device in the housing. Providing a braille message on the outer surface of the housing. This and other implementations can each optionally include one or more of the following features.

### TECHNICAL FIELD

This invention relates to message delivery for the visually impaired, particularly, delivering braille messages.

### BACKGROUND

Written communications can be conducted with visually impaired persons using braille messages.

### SUMMARY

Implementations of the present disclosure generally relate to a method and device for delivering a messages to visually impaired persons. More particularly, implementations of the present disclosure are directed to a method for delivering messages to visually impaired children with an audible braille message delivery device.

In one aspect the invention features a method for delivering a message to a visually impaired person. The method includes providing a device including a housing with an inner chamber and an outer surface, a power source, and a sound producing device coupled to the power source. The power source and sound producing device are contained within the inner chamber of the housing. Providing a mechanism to activate the sound producing device in the housing. Providing a braille message on the outer surface of the housing. This and other implementations can each optionally include one or more of the following features.

In some implementations, the housing has an egg-shape. In some implementations, the housing includes an aperture extending from the outer surface to the inner chamber. In some implementations, the braille message can be embossed on the outer surface of the housing.

In some implementations, the housing includes a first portion and a second portion engaged with the first portion. In some implementations, the housing is egg-shaped where the first portion forms a first hemisphere of the housing and the second portion forms a second hemisphere of the housing. In some implementations, the mechanism to activate the sound is a switch.

In some implementations, the device includes a wireless signal receiver configured to receive a control signal and activate the sound producing device in response to the control signal. In some implementations, the mechanism to activate the sound producing device is a wireless transmitter configured to send the control signal to the wireless signal receiver.

In some implementations, the method includes hiding the device, and activating the sound producing device using the mechanism to permit a visually impaired person to find the device by listening for sound produced by the sound producing device and, upon finding the device, to read the braille message on the outer surface of the housing.

In one aspect the invention features a method for delivering a message to a visually impaired person. The method includes providing a device including a housing, a power source, and a sound producing device coupled to the power source. The housing includes an inner chamber and a braille message on an outer surface of the housing. The power source and sound producing device are contained within the inner chamber of the housing. Providing a mechanism to activate the sound producing device in the housing. Hiding the device. Activating the sound producing device using the mechanism to permit a visually impaired person to find the device by listening for sound produced by the sound producing device, and, upon finding the device, to read the braille message on the outer surface of the housing. This and other implementations can each optionally include one or more of the following features.

In some implementations, the housing includes an aperture extending from the outer surface to the inner chamber. In some implementations, the braille message is embossed on the outer surface of the housing.

In some implementations, the housing includes a first portion and a second portion engaged with the first portion. In some implementations, the housing is egg-shaped where the first portion forms a first hemisphere of the housing and the second portion forms a second hemisphere of the housing. In some implementations, the mechanism to activate the sound is a switch.

In some implementations, the device includes a wireless signal receiver configured to receive a control signal, and activate the sound producing device in response to the control signal. In some implementations, the mechanism to activate the sound producing device is a wireless transmitter configured to send the control signal to the wireless signal receiver.

In one aspect the invention features a method for delivering a message to a visually impaired person. The method includes providing a message delivery device. The device includes an egg-shaped housing having a first portion, a second portion, a power source, and a sound producing device coupled to the power source. The first portion forms a first hemisphere of the housing, and the second portion forms a second hemisphere of the housing. The second portion engages with the first portion to form an inner chamber. The power source and sound producing device are contained within the inner chamber of the housing. The first portion includes a plurality of oval shaped apertures that permit sound from the sound producing device to exit the inner chamber. Providing a mechanism to activate the sound producing device in the housing. Providing a braille message embossed on an outer surface of the first portion of the housing. The first portion includes a plurality of oval shaped apertures that permit sound from the sound producing device to exit the inner chamber. This and other implementations can each optionally include one or more of the following features.

In some implementations, the method includes hiding the device, and activating the sound producing device using the mechanism to permit a visually impaired person to find the device by listening for sound produced by the sound producing device and, upon finding the device, to read the braille message on the outer surface of the housing.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a front view of an example message delivery device.

FIG. 1B is perspective view of an example message delivery device.

FIGS. 2A and 2B depict block diagrams of example sound producing systems for a message delivery device.

FIG. 3 depicts a flowchart of an example method for delivering a message to a visually impaired person.

Like reference symbols in the various drawings indicate like elements.

### DETAILED DESCRIPTION

Implementations of the present disclosure generally relate to a process and device for delivering a messages to visually impaired persons. More particularly, implementations of the present disclosure are directed to a method for delivering messages to visually impaired children in game-like forum. The present disclosure provides methods and devices that enable visually impaired children to engage in hide-and-seek type games, e.g., Easter egg or treasure hunts, and receive uplifting messages when the children are successful.

In some implementations, a message delivery device is provided with a braille message on an outer surface. The message delivery device can be given an appropriate shape for a particular game or season. For example, the message delivery device can be shaped like an Easter egg for Easter egg hunts, a gift box for Christmas or birthdays, or a treasure chest for treasure hunts. The message delivery device is provided with a sound producing system and a mechanism to activate the sound producing system. A game, e.g., Easter egg hunt, may begin when a single or multiple message delivery devices are hidden or otherwise placed in a location away from the children participating in the game and the device(s) are activated to produce sounds that guide the children towards the device(s). Upon finding a device, a child can feel along the outer surface of the device to find a special braille message, e.g., “God Loves You,” “You Are Beautiful,” or “You Are Special to God.”

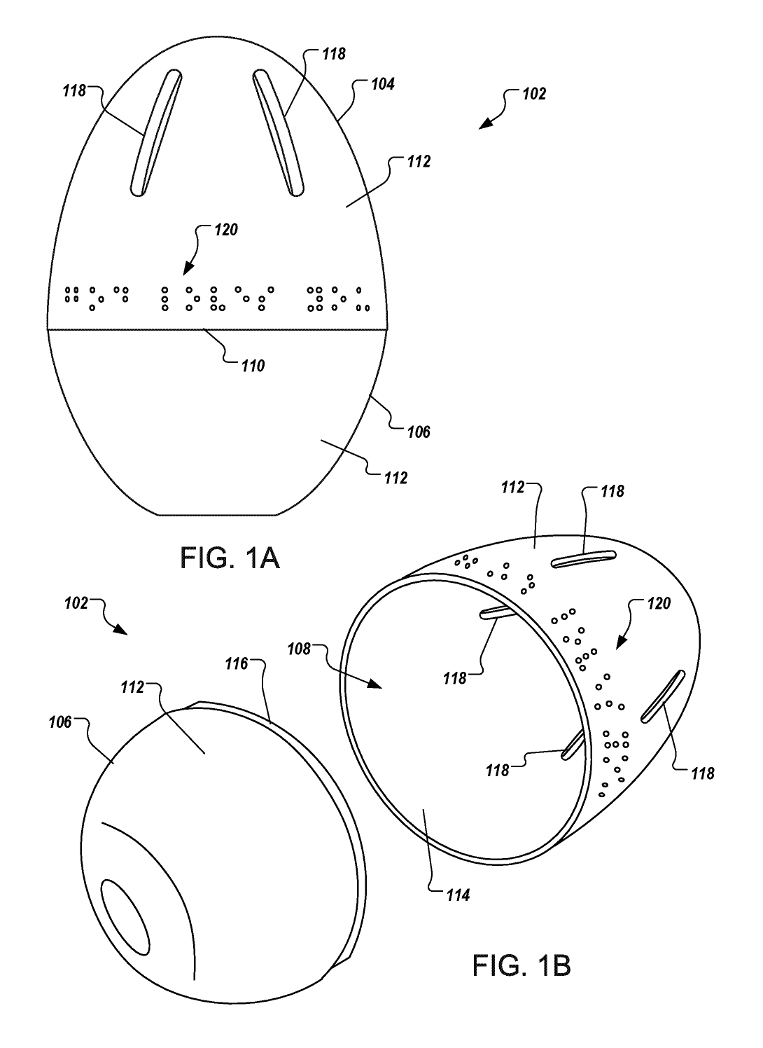

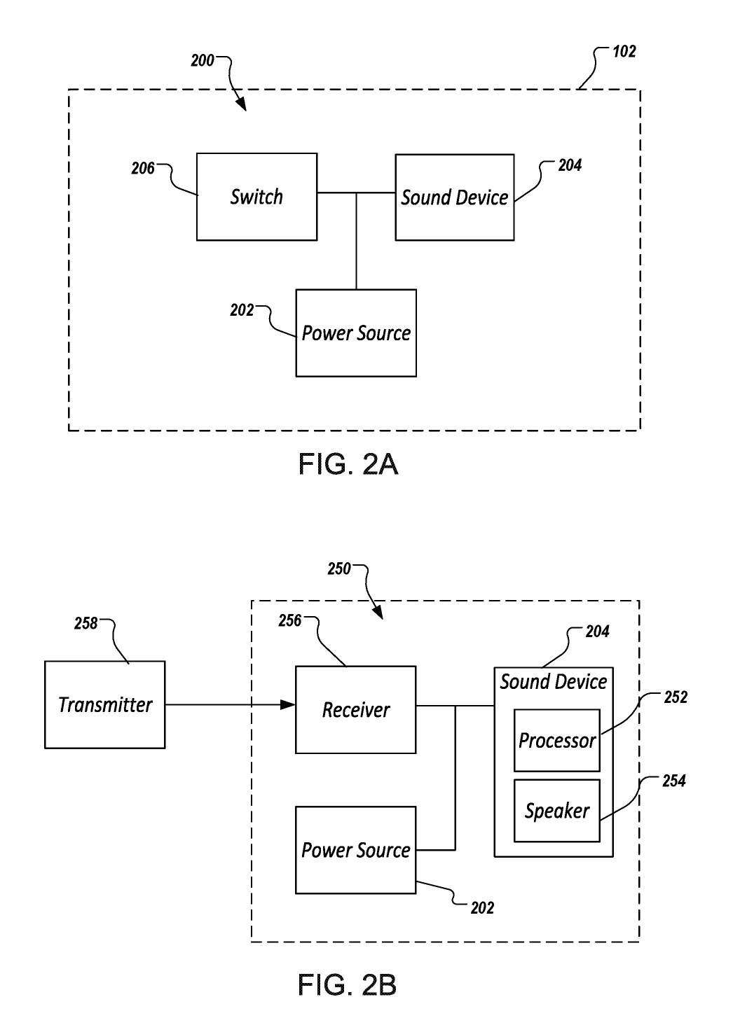

FIGS. 1A and 1B depict a front view and a perspective view, respectively, of housing 102 of an example message delivery device. The housing 102 includes first portion 104 and a second portion 106. The first portion 104 and the second portion 106 engage with each other at an interface 110 to form an inner chamber 108 which contains a sound producing system (described in more detail below in reference to FIGS. 2A and 2B). Both the first portion 104 and the second portion 106 have an outer surface 112 and an inner surface 114. In the example shown, the housing 102 has an egg-shape and each portion 104, 106 forms a hemisphere of the egg-shape. The term “hemisphere” is not used in the strict geometric sense as half of a sphere, but more loosely to include, e.g., one of two portions of a generally curved object. In other examples, the housing 102 can be shaped as a gift box, e.g., for Christmas or birthdays or a treasure chest, e.g., for treasure hunts.

The first portion 104 and second portion 106 can be attached to each other by engaging a lip 116 formed on the second portion 106 with the corresponding inner surface 114 of the first portion 104. Although the lip 116 is illustrated as being formed on the second portion 106, in some examples, the lip 116 can be formed on the first portion 104. In some examples, the lip 116 and corresponding inner surface 114 form a friction tight fit. In some implementations, the lip 116 and inner surface 114 can each include corresponding threading to form a threaded connection.

One or both of the first portion 104 and the second portion 106 includes an aperture 118 passing from the outer surface 112 through the inner surface 114. The aperture(s) 118 permit sound from the sound producing system to exit the inner chamber 108 of the housing 102. For example, the illustrated housing 102 includes four oval-shaped apertures 118 located in the first portion 104 of the housing 102.

The outer surface 112 of one or both of the first portion 104 and the second portion 106 includes a braille message 120. In some implementations, the braille message 120 can be removably attached to the outer surface 112, e.g., a sticker embossed with braille. In some implementations, the braille message 120 is embossed on the outer surface 112. The braille message 120 can be a seasonably appropriate message. For example, for Easter the braille message 120 can be a message such as “God Loves You,” “You Are Beautiful,” or “You Are Special to God.” For a birthday, the braille message 120 can be a message such as “Happy Birthday” or “Wow, You're So Big.” For a treasure hunt, the braille message 120 can be a message such as “You Found the Treasure,” “X Marks the Spot,” or “100 Pieces of Gold.”

FIGS. 2A and 2B depict block diagrams of example sound producing systems 200, 250 for a message delivery device. As discussed above, sound producing systems 200, 250 are contained within the housing 102. Referring first to FIG. 2A, one example sound producing system 200 includes a power source 202 coupled to a sound producing device 204 and a mechanism 206 for activating the sound producing device 204, e.g., a switch. The power source 202 can be a battery (e.g., a 9V battery), a solar power cell, or other appropriate device, for example. The sound producing device 204 can be a buzzer or beeper, for example. In some implementations, the sound producing device 204 can include a sound producing circuit and speaker (e.g., as described in more detail below in reference to FIG. 2B). The power source 202 is electrically connected to the sound producing device 204 to provide power to the sound producing device 204 when the sound producing system 200 is activated by the mechanism 206. For example, the mechanism 206 can be a switch that interrupts electrical power supplied to the sound producing device 204. In some implementations, the mechanism 206 can simply be an electrical connection between the power source 202 and the sound producing device 204.

Referring to FIG. 2B, second example sound producing system 250 includes a power source 202 coupled to a sound producing device 204. As noted above, the sound producing device 204 can include a sound producing circuit (processor 252) coupled to a speaker 254. For example, the processor 252 can be an integrated circuit (IC) programmed with to generate melodies or songs (e.g., the UM66 melody generator IC).

In addition, sound producing system 250 includes a receiver 256 and mechanism 206 for activating the sound producing device 204, e.g., transmitter 258. The receiver 256 can be a wireless signal receiver configured to receive a control signal from the transmitter 258 to activate the sound producing device 204. For example, the receiver 256 and transmitter 258 can be a low power radio frequency receiver and transmitter or an infrared receiver and transmitter. The receiver 256 interfaces with the sound producing device 204 to control the operation of the sound producing device 204 using the transmitter 258. For example, the receiver 256 can interface with the processor 252 of the sound producing device 204 to activate a song or melody, upon receiving a control signal from the transmitter 258.

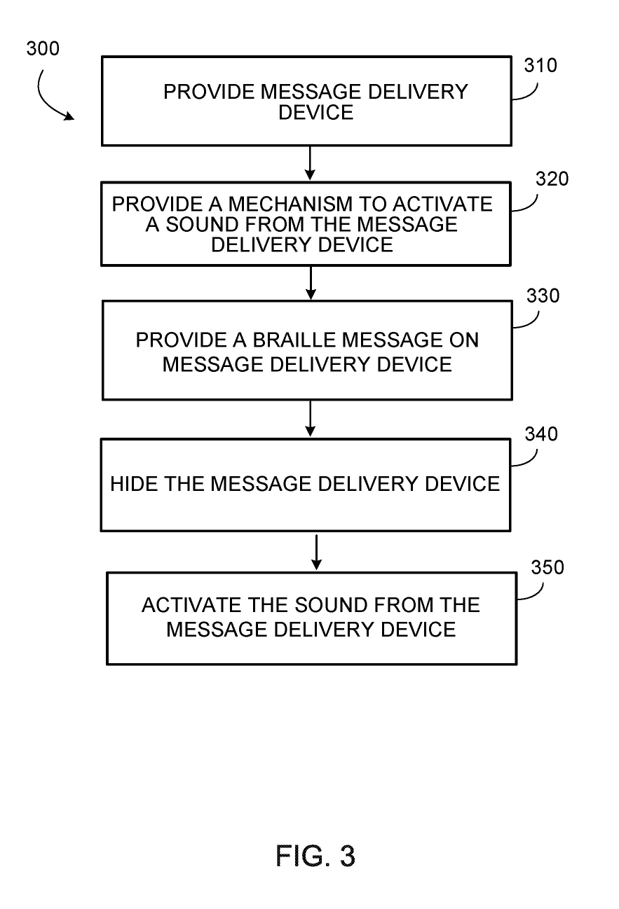

FIG. 3 depicts a flowchart of an example method for delivering a message to a visually impaired person. Briefly, the process 300 includes: providing a message delivery device (310), providing a mechanism to activate a sound from the message delivery device (320), providing a braille message on the message delivery device (330), hiding the message delivery device (340), and activating the sound from the message delivery device (350).

In more detail the process 300 includes providing a message delivery device (310). For example, a message delivery device can include a housing with sound producing system containing in an inner chamber of the housing, e.g., as described above in reference to FIGS. 1A and 1B. The sound producing system can include a power source and a sound producing device coupled to the power source, e.g., as described above in reference to FIGS. 2A and 2B. A mechanism to activate a sound from the message delivery device is provided (320). In some implementations, the mechanism to activate the sound producing device can be a switch. In some implementations, the message delivery device includes a wireless signal receiver and the mechanism to activate the sound producing device is a wireless transmitter. A braille message is provided on the message delivery device (330). For example, a braille message is provided on an outer surface of the message delivery device housing. In some implementations, the braille message is removably attached to the outer surface. In some implementations, the braille message is embossed on the outer surface.

The message delivery device is hidden (340). For example, one or more message delivery devices can be placed in a location away from the children participating in a game with the message delivery device(s). The sound from the message delivery device is activated (350). For example, the sound producing device in the message delivery device can be activated using the mechanism (e.g., a switch or wireless transmitter). Activating the sound from the message delivery device permits a visually impaired person to find the device by listening for sound produced by the sound producing device and, upon finding the device, to read the braille message on the outer surface of the housing.

For example, a game such as an Easter egg hunt may begin when a single or multiple message delivery devices are hidden or otherwise placed in a location away from the children participating in the game and the device(s) are activated to produce sounds that guide the children towards the device(s). Upon finding a device, a child can feel along the outer surface of the device to find a special Easter message in braille, e.g., “God Loves You,” “You Are Beautiful,” or “You Are Special to God.”

While a number of examples have been described for illustration purposes, the foregoing description is not intended to limit the scope of the invention, which is defined by the scope of the appended claims. There are and will be other examples and modifications within the scope of the following claims.

What is claimed is:

1. A method for delivering a message to a visually impaired person, the method comprising:
providing a device comprising:
an egg-shaped housing comprising:
a first portion that forms a first hemisphere of the housing, and
a second portion that forms a second hemisphere of the housing and that engages with the first portion to form an inner chamber,
a power source, and
a sound producing device coupled to the power source, wherein the power source and sound producing device are contained within the inner chamber of the housing;
providing a mechanism to activate the sound producing device in the housing; and
providing a braille message embossed on an outer surface of the first portion of the housing, and
wherein the first portion comprises a plurality of oval shaped apertures that permit sound from the sound producing device to exit the inner chamber.

2. The method of claim 1, further comprising:
hiding the device; and
activating the sound producing device using the mechanism to permit a visually impaired person to:
find the device by listening for sound produced by the sound producing device and,
upon finding the device, read the braille message on the outer surface of the housing.

3. A method for delivering a message to a visually impaired person, the method comprising:
providing a device comprising:
a housing including an inner chamber and an outer surface,
a power source, and
a sound producing device coupled to the power source, wherein the power source and sound producing device are contained within the inner chamber of the housing;
providing a mechanism to activate the sound producing device in the housing; and
providing a braille message on the outer surface of the housing.

4. The method of claim 3, wherein the housing has an egg-shape.

5. The method of claim 3, wherein the housing comprising an aperture extending from the outer surface to the inner chamber.

6. The method of claim 3, wherein the braille message is embossed on the outer surface of the housing.

7. The method of claim 3, wherein the mechanism to activate the sound is a switch.

8. The method of claim 3, wherein the housing comprises a first portion and a second portion engaged with the first portion.

9. The method of claim 8, wherein the housing is egg-shaped and the first portion forms a first hemisphere of the housing and the second portion forms a second hemisphere of the housing.

10. The method of claim 3, wherein the device further comprises a wireless signal receiver configured to receive a control signal and, in response to the control signal, activate the sound producing device.

11. The method of claim 10, wherein the mechanism to activate the sound producing device is a wireless transmitter configured to send the control signal to the wireless signal receiver.

12. The method of claim 3, further comprising:
hiding the device; and
activating the sound producing device using the mechanism to permit a visually impaired person to:
find the device by listening for sound produced by the sound producing device and,
upon finding the device, read the braille message on the outer surface of the housing.

13. A method for delivering a message to a visually impaired person, the method comprising:
providing a device comprising:
a housing including an inner chamber and a braille message on an outer surface of the housing,
a power source,
a sound producing device coupled to the power source, wherein the power source and sound producing device are contained within the inner chamber of the housing;
providing a mechanism to activate the sound producing device in the housing;
hiding the device; and
activating the sound producing device using the mechanism to permit a visually impaired person to:
find the device by listening for sound produced by the sound producing device, and
upon finding the device, read the braille message on the outer surface of the housing.

14. The method of claim 13, wherein the housing comprises an aperture extending from the outer surface to the inner chamber.

15. The method of claim 13, wherein the braille message is embossed on the outer surface of the housing.

16. The method of claim 13, wherein the mechanism to activate the sound is a switch.

17. The method of claim 13, wherein the housing comprises a first portion and a second portion engaged with the first portion.

18. The method of claim 17, wherein the housing is egg-shaped and the first portion forms a first hemisphere of the housing and the second portion forms a second hemisphere of the housing.

19. The method of claim 13, wherein the device further comprises a wireless signal receiver configured to receive a control signal and, in response to the control signal, activate the sound producing device.

20. The method of claim 19, wherein the mechanism to activate the sound producing device is a wireless transmitter configured to send the control signal to the wireless signal receiver.
